(19) United States
(12) Patent Application Publication
(10) Pub. No.: US 2007/0005312 A1
(43) Pub. Date: Jan. 4, 2007

(54) Method and apparatus of determining parameterizations and distances for feature frame modeling using attribute based modeling

(76) Inventor: Christopher Bateman, Elbert, CO (US)

Correspondence Address: Christopher Bateman, 18125 Elbert Road, Elbert, CO, 80106, US

(21) Appl. No.: 11/457,797

(22) Filed: Jul. 15, 2006

Related U.S. Application Data
(63) Continuation-in-part of application No. 10/939,442, filed on Sep. 14, 2004, now abandoned.

(51) Int. Cl. G06F 17/10

(52) U.S. Cl. 703/2

(57) ABSTRACT

Attribute Based-Modeling surfaces requires uniform methods of calculating distances and weights in parameter space in order to create smooth and fair surfaces. This invention provides several methods of calculating distances and weights that have different characteristics yielding well behaved surfaces. The methods are computationally efficient and produce surfaces that are fair and smooth and have certain minimal energy characteristics that are desirable to various industries.

### FIELD OF THE INVENTION

The invention relates generally to the art of modeling surfaces and shapes of objects, and more particularly to computer implemented methods for designing shapes and representing shapes using Attribute Based Modeling. Attribute Based Modeling is a method whereby geometric models are free from constrains usually associated with computer modeling including n-number of sides to patches and even modeling with infinite surfaces. The invention can be applied to industries such as, but not limited to, internet advertising, animation, automotive, aerospace, CAD/CAM, product design, geophysical exploration, and computer games.

### BACKGROUND OF THE INVENTION

In prior art, object shape is usually described or modified with a set of points or curves in space. Hoschek, Joseph and D. Lasser, Fundamentals of Computer Aided Geometric Design (1993) summarize many of these methods. In U.S. patent application Ser. No. 10/939,442 a new method is described which improves the design and modeling of shapes over the traditional methods. This invention improves on the method described in U.S. patent application Ser. No. 10/939,442 by defining methods to compute the distances and parameterizations necessary for the previously said patent application Ser. No. 10/939,442. In prior art, patent application Ser. No. 10/939,442, Attribute Based Modeling surfaces are defined using a set of points or curves in space and does not assume any specific method for calculating distances in Parameter Space nor any method for determining weights in Parameter Space

All industries using Attribute Based Modeling surfaces are concerned about computational speed and efficiency. Additionally, anomalies in the Attribute Based Modeling surface can arise from various distance calculation methods. These anomalies can cause the Attribute Based Modeling surface to kink or cause ripples to propagate farther than would be expected given the input features.

One of the major goals of Attribute Based Modeling is to produce a surface that has certain minimal energy properties. These properties can only be achieved by careful application of distance calculation and weight calculation methods. Many methods will not achieve a high degree of surface continuity or esthetic beauty (see Schneider, J. Solving the Nearest Point on the Curve Problem. 1990). Additionally, industries such as fluid computation and aerospace are concerned about surface fairness to maintain smooth fluid flows.

The invention overcomes deficiencies of previous surface modeling methods in several ways:

First, as the number of design curves increase, the additional computation is increased linearly as opposed to most technologies, which increases to the square of the number of design curves (see Farin, G. Curves and Surfaces for CAGD A Practical Guide, Fifth Edition. 2002).

Second, patch shape and number of points are arbitrary. In traditional methods such as those described in described in Hoschek, Joseph and D. Lasser, Fundamentals of Computer Aided Geometric Design (1993) and Barnhill and Riesenfeld, eds Computer Aided Geometric Design Academic Press (1974), the patch geometry and number of sides are fixed.

Third, the invention can display difficult and previously impossible surfaces, such as non-differentiable surfaces like fractals. In prior art described in Hoschek, Joseph and D. Lasser, Fundamentals of Computer Aided Geometric Design (1993), surfaces are described as using differentiable surfaces.

Fourth, the invention allows for the arbitrary movement of placed features. Currently, this cannot be done because of the inflexibility and instability of present technology.

Fifth, the technology can mix points, lines, curves, surfaces, and hyper-surfaces without limitation. The only prior art method capable of mixing line, curves and points is described in Singh, Karan and E. Fiume, “Wires: A Geometric Deformation Technique,” Computer Graphics Proc., 1998, pp 405-414, and U.S. Pat. No. 6,204,860. It is deficient relative to the invention because computation is iterate and subject to singularities in computation.

Sixth, there is no need for the features to be connected in any way, and they may overlap one another with no adverse effects.

Seventh, current technology as generally described in G. Farin, Curves and Surfaces for CAGD: A Practical Guide, Morgan-Kaufmann Publishers. San Francisco (1964) and Hoschek, Joseph and D. Lasser, Fundamentals of Computer Aided Geometric Design (1993), uses careful mapping to ensure that texture mapping boundaries match across patches. Since large surfaces can be described across multiple patches with the present invention, large texture maps can now be used, thereby addressing this problem.

Eighth, the surface can be manipulated, as was demonstrated previously in patent application Ser. No. 10/939,442, not only by the features, but through changing functions so that the slopes, curves, surface normal, and derivatives can be controlled.

A critical element of the invention described in the current invention is implemented on a computer graphics system. FIG. 1 shows computing a distance to footprints and parameterizing those footprints.

This invention allows for more accurate and smooth use of Attribute Based Modeling surfaces in industries such as, but not limited to, internet advertising, animation, automotive, aerospace, oil exploration, seismic activity CAD/CAM, geophysical exploration, product design, and computer games.

### BRIEF SUMMARY OF THE INVENTION

The current invention is implemented on a computer graphics system. FIG. 1 shows an example of computing distance and parameterization. For a given point, uᵢ, in parameter space the distance is the length of the perpendicular line segment from uᵢ to the footprint within the perpendicular range of the footprint; or the distance to one of the endpoints outside the perpendicular range of the footprint. The proportion of the line segment from one endpoint of the footprint to the point of the perpendicular projection to the entire length of the footprint is the parameterization of the point. FIG. 2 shows how the distance and parameterization computation are included in the larger method of patent application Ser. No. 10/939,442. In patent application Ser. No. 10/939,442 no specific distance or parameterization methods are implemented. This invention applies several different distance and parameterization methods with various benefits and computation costs.

The exemplary method describe above is called the Euclidean distance and parameterization. Other variations for computing distance and parameterization claimed are called elliptic, stellated and discrete convolution.

### BRIEF DESCRIPTION OF THE DRAWINGS

FIG. 1 is a flow chart of the distance computation process

FIG. 2 illustrates equidistant contours of Euclidean distance to linear footprints using a perpendicular sweep.

FIG. 3 shows a surface computed with Euclidean distance and the resulting kink in the surface.

FIG. 4 shows the ideal t-value graph for ellipsoidal distance.

FIG. 5 shows a surface computed with Elliptical Distance and the resulting smooth surface.

FIG. 6 is an example of computing distance and parameterization on a footprint called Elliptical Distance.

FIG. 7 is an example of computing distance and parameterization on a footprint called Stellated Distance.

FIG. 8 is an example of computing distance and parameterization on a footprint called Discrete Convolution Distance.

### DETAILED DESCRIPTION OF THE INVENTION

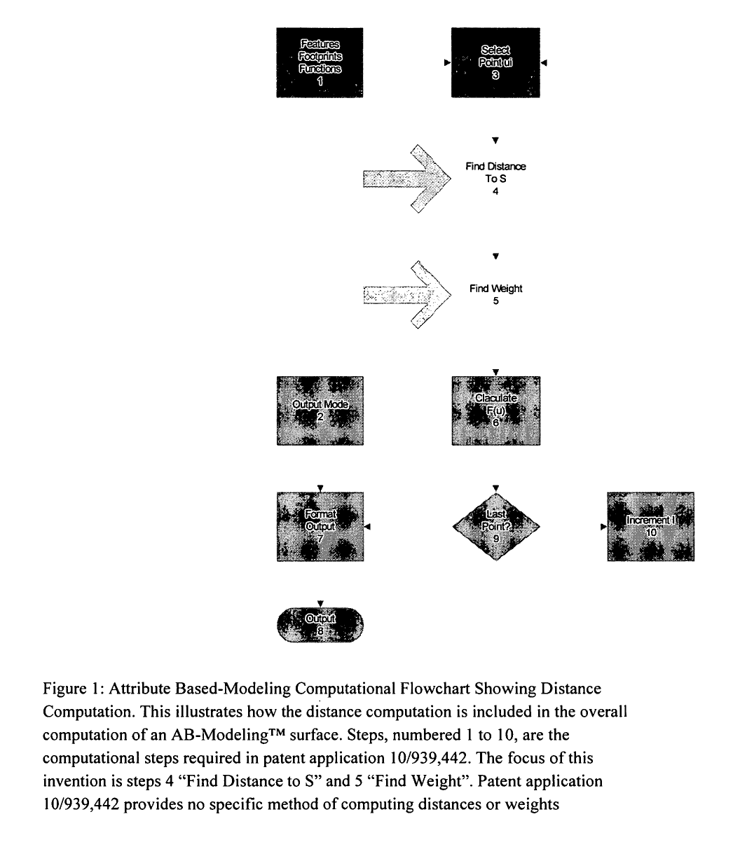

Patent application Ser. No. 10/939,442, is applied to graphical objects that are designed, manipulated or deduced by interpolating a curve, surface or hypersurface through a plurality of input features that are independently given curves, surfaces or hypersurfaces with associated derivative information. In FIG. 1 the features do not require any specified configuration connectivity information. Step 1 consists of the following initializations: allows the user to select a dimension within which to work, allows the modeler to define the features by inputting points, lines, surfaces, or hyper surfaces, defines the footprint for the features in parameter space, and defines the functions that relate the footprints. Step 2 determines the output mode.

Patent application Ser. No. 10/939,442, begins with a Euclidean manifold of n dimensions. We let u be a point on the manifold with coordinates (u₁, u₂, . . . uₙ). This manifold is called parameter space and the point u is called the parameter. In FIG. 1, step 1: when the user gives an input called a feature, it is defined on an m dimensional manifold called object space. It is a necessary step to define a corresponding input as a subset of parameter space, which is called the footprint (also step 1). The footprint is typically the same dimension as the feature, although not necessarily. Also given by the user is a function that maps a point on the footprint to a point on the feature (also step 1). Hence inputs come in triples: footprint, feature and function.

In a simple example, the footprint is a point in a two-dimensional space and the feature is a point in three-dimensional space given by adding a height value to the footprint. The addition of the height value also defines the function between the two points. As seen in Steps 3 and 5 of FIG. 1, to further compute a shape with the invention, there must exist a method by which a distance d(u, S) between a point, u, in parameter space and a footprint, S, can be computed. This patent application develops the general distance function based on the point, u, and the footprint, S. In the previous simple example, the distance d(u, v) between u and the footprint v=(v₁, v₂) could be simply the Euclidean distance of
d(u,S)=[(u₁−u₂)²+(v₁−v₂)²]^{1/2} (1)
or it could be any so-called lₚ norm
d(u,S)=[(u₁−u₂)^{p}+(v₁−v₂)^{p}]^{l/p} (2)
where p is any positive real number; or it could be the max norm
d(u,S)=max(|u₁−u₂|,|u₁−u₂|). (3)
Other distances methods are discussed below.

Step 5, is to compute a weighting function W (u, S) from the distance function d(u, S). The requirement of the weight function is that it grows to infinity as the distance function goes to zero, that is as the point u approaches the footprint. An obvious way to achieve this behavior is to define the weight function as the reciprocal of the distance function; thus W (u, S)=1/d(u, S). Step 6 of FIG. 1, in computing a point on the surface is to calculate the weighted least squares of the object points on the features, where the weighting functions are given as above as reciprocals to the distances.

Once calculated the value of the point on the object can be output in a number of graphical forms (Step 7). The user may choose to output (Step 8) the result as a polygonal mesh in which the evaluated points of the iterated loop (Step 9) are vertices.

The new art of this patent application is in the Find Distance step (Step 4) in the Attribute Based Modeling flow, as highlighted in FIG. 1. One of the hallmarks of Attribute-Based Modeling is that it is computationally light, and yet has an ability to handle a robust range of modeling features. One of the reasons Attribute Based Modeling can accomplish this is because many of the calculations are accomplished in parameter space. The key to the calculations is the distance and weight measurements.

Subtle differences in the method of calculating distances and weights causes unsubtle and undesirable effects in the rendered surface. Additionally, some methods for calculating distances are more computationally expensive than others. This invention covers several methods for calculating distances and weights.

For each point u=(u,v) in parameter space and for each foot print Uᵢ there are two computations that need to be made: first, the distance sᵢ from u to the footprint Uᵢ, and second, the parameter value, tᵢ, on the footprint at which the attribute function, ƒᵢ, is evaluated. Both sᵢ and tᵢ are functions of (u,v). Where the footprint in question is obvious we will simply refer to s and t.

First, a method of measuring distance and weight using the Euclidian method is used. For a footprint that is a line segment AB from start point A=(Aₓ, A_{y}) to end point B=(Bₓ, B_{y}), the simplest way to compute s and t is to find the point pᵤ, which is the perpendicular projection of u to the line that passes through A and B. That is to say, the line segment upᵤ will be perpendicular to AB. The formula for finding pᵤ is, first, to find the parameter value t of pᵤ and then plug into the linear interpolant to give the following equation:
t=[(Aₓ−u)(Aₓ−Bₓ)+(A_{y}−v)(A_{y}−B_{y})]/[(Aₓ−Bₓ)²+(A_{y}−B_{y})²] (4)

If pᵤ exists outside of the start and end points of AB (t is not in [0, 1]), then it is set equal to the closest of A or B; thus if t<0, then pᵤ=A, or if t>1, then pᵤ=B . The distance s is then:
s(u,v)=∥u−pᵤ∥ (5)
We refer to this as the Euclidean distance. The parameter value t is equal to:
t(u,v)=∥pᵤ−A∥/∥B−A∥ (6)

From this it is clear that the parameter t will range from 0 to 1. This will be scaled to match the domain of the attribute function associated with it.

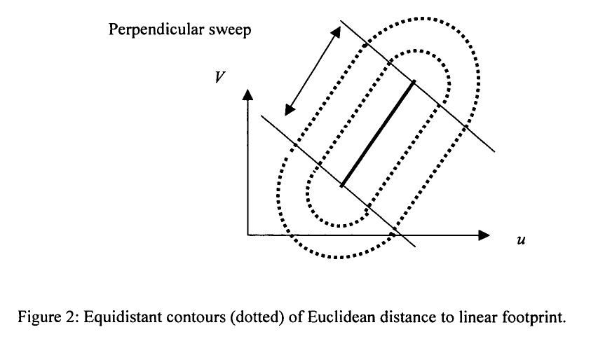

Euclidean distance is computationally efficient and works well for three- and four-sided patches where the footprints are in triangular or rectangular configurations. It has a shortcoming, when two footprints come together in an angle greater than 90 degrees or when it is used for floating curves, however it does work for points. FIG. 2 illustrates the problem. The dark line segment is the footprint. The dotted lines represent equidistant contours of the Euclidean distance. They are straight lines connected by semi-circles at the ends. The contours have second order discontinuities where the parameter point moves outside the area where its perpendicular projection is on the line segment between endpoints, i.e. the perpendicular sweep area.

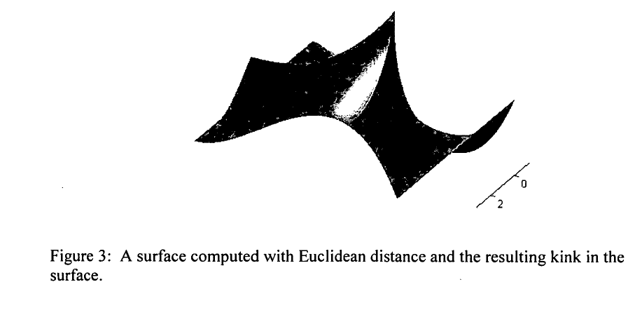

The higher order discontinuity in the Euclidean distance method is manifested in renderings, which yield a second-order discontinuity propagating from the ends of the dangling feature. FIG. 3 shows a four-sided surface with a floating curve in the center. The margin of the perpendicular sweep can be seen as seam in the surface.

To solve this problem, we engineered a novel distance method called ellipsoidal distance and a corresponding parameterization method. The ellipsoidal distance from point P to a line segment AB is defined as follows:
s=∥PA∥+∥PB∥−∥AB∥ (7)
Parameterization is given by:
t=∥PA∥/(∥PA∥+∥PB∥) (8)

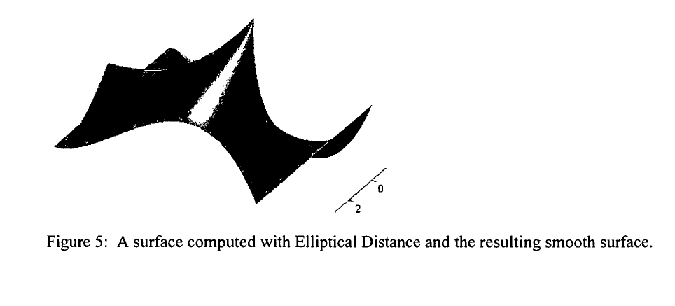

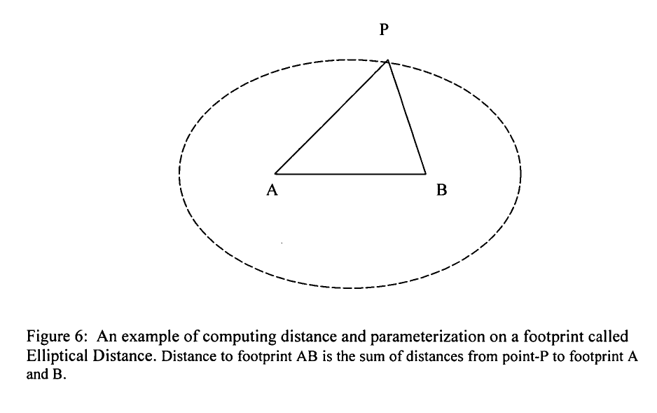

As shown in FIG. 6, this method results in a distance contour that is smooth everywhere: an ellipsoid. It solves the appearance of the seam as in FIG. 3. FIG. 5 shows the same floating edge with ellipsoidal distance. The surface is smooth.

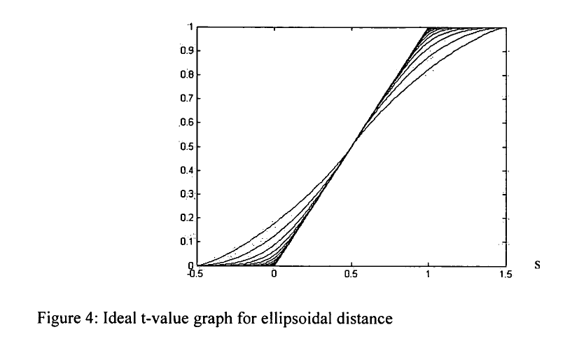

However, the t-value can behave in a non-intuitive manner is some cases. For instance, as P approaches infinity in either direction on the footprint line, we have ∥PA∥=∥PB∥, and hence t=½. This is clearly a problem; t should be 0 or 1, depending on the side of the line segment it is on. Ideally, we would like our t-value graph to behave like the function in FIG. 4. When P lies on AB or its extension, the function should be the thick blue line. As P goes further away, the corners that correspond to the end of AB's perpendicular sweep become progressively rounder.

One solution is to use a super ellipse function, which is derived in the following steps:

For t∈[0, 0.5], we have:
s=(−1)ⁿ⁺¹(sin θ)ⁿ,t=(cos θ)ⁿ, where θ∈[3π/2,2π], (step 1: super ellipse)
s=s+t, (step 2: skew)
s=s/2,t =t/2, (step 3: scale)
For t∈ [0.5, 1], we have:
s=(sin θ)ⁿ, t=(−1)ⁿ⁺¹(cos θ)ⁿ, where θ∈[π/2,π], (step 1: super ellipse)
s=s+t, (step 2: skew)
s=s/2+1,t=t/2+1, (step 3: scale and translate) (9)

Notice that the above function does not have an explicit form. Since n is inversely proportional to the Euclidean distance from P to AB, a lookup table with fine enough resolution is the natural for the purpose of implementation.

Stellated distance is another distance formula that works for any convex polygonal footprints. Stellated distance was generally first used by Gregory for 5-sided patches only as described in Malraison, P. 1999. Multi-sided Surfaces: a Survey. Curve and Surface Design (1999). We have extended its use to n-sided convex polygons in Attribute Based Modeling. It is described as follows:

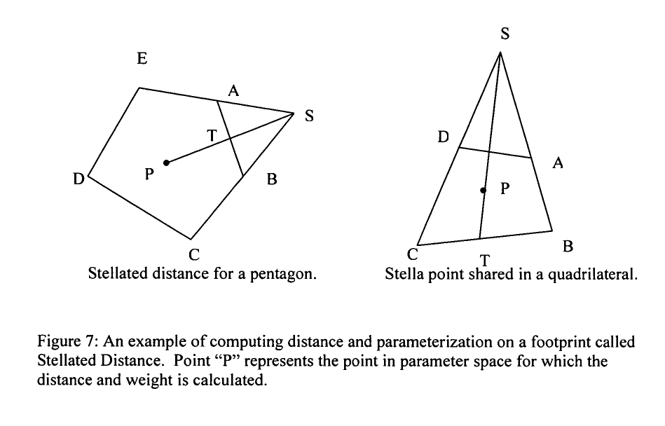

Begin by computing a stella point for each edge. For example, in FIG. 7, we have a pentagonal footprint ABCDE. For edge AB, its stella point is the intersection of the two line segments EA and BC, which are the two neighboring edges of AB. Take a point inside the polygon, P, PS forms a line segment which intersects AB at point T. In some cases, such as in FIG. 7, two footprints can share the same stella point; footprint BC intersects the extension of PS at T. The Euclidean distance between P and T is the stellated distance for a point P to a line footprint AB.

Since PS and AB intersect within AB, the parameter t in T=(1−t)A+tB ranges from 0 to 1. It also gives a parameterization to the parametric attribute curve in the feature space.

In the case of a triangle footprint, each edge's stella point is simply its opposite vertex. Another special case is when the two neighboring edges of a footprint are parallel. In this case, simply use the perpendicular (Euclidean) distance from point P to the footprint AB.

Stellated distance operates efficiently for all footprints that are convex polygons, and it yields fair and smooth surfaces with good polygon distributions. However, there is no means of extending its use to floating edges or interior points, nor can it handle 2-sided patches.

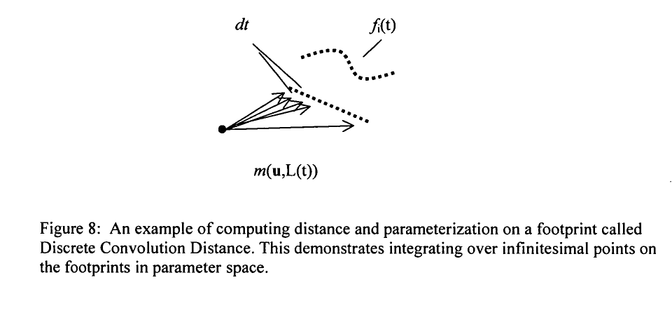

Another novel method to compute distance to a footprint is the convolution method in which the distance from a parameter point u to the footprint L(t) is measured to infinitesimally closely spaced points on the footprints and then integrated with the attribute functions as indicated in FIG. 8. In the figure, ƒᵢ is the attribute function over the footprint, dt is the infinitesimal space between points on the footprint and m(u,L(t)) is a metric between the parameter u and the point of the footprint L at parameter t.

Formally, the convoluational form for u to L(t) is defined as follows:

$$F ( u , L ( t ) ) = {\int }_{L} {f}_{i} ( t ) \frac{m ( u , L ( t ) )}{{\int }_{L} m ( u , L ( t ) ) ⅆ t} ⅆ t \qquad ( 10 )$$

This form has the advantage that the t-value calculation is eliminated, much as in calculating distance to a point, and it is separable. The latter means that the footprint can be subdivided with its attribute function and the subdivided version is equivalent to the original version. One advantage of a convolution method is that it can handle dangling edges smoothly.

What is claimed is:

1. A computer-implemented method for calculating distance and weight in an Attribute Based Modeling parameter space (prior art patent application Ser. No. 10/939,442) wherein Euclidian distances are used as known in the art in other applications, which is the perpendicular projection of any selected interior point u to the line that passes through a footprint that is a line segment AB.

2. A computer-implemented method for calculating distance and weight in an Attribute Based Modeling parameter space (prior art patent application Ser. No. 10/939,442) wherein ellipsoidal distances are used as known in the art in other applications, which is the ellipsoidal distance from any interior point u to a footprint that is a line segment, including super ellipse function.

3. A computer-implemented method for calculating distance and weight in an Attribute Based Modeling parameter space (prior art patent application Ser. No. 10/939,442) wherein Stellated distances are used, which is the stella point at the intersection of the two line segments EA and BC, which are the two neighboring edges of AB, all footprint line segments.

4. A computer-implemented method for calculating distance and weight in an Attribute Based Modeling parameter space (prior art patent application Ser. No. 10/939,442) wherein the convolution method is used as known in the art in other applications, in which the distance from a parameter point u to the footprint L(t) is measured to infinitesimally closely spaced points on the footprints and then integrated with the attribute functions.
